(19) United States
(12) Patent Application Publication
(10) Pub. No.: US 2010/0215333 A1
(43) Pub. Date: Aug. 26, 2010

(54) IMAGE AUDIO REPRODUCTION SYSTEM, AV AMPLIFICATION DEVICE AND PROGRAM

(75) Inventor: Yoshitsugu Kojima, Hachiouji (JP)

Correspondence Address: Robinson Intellectual Property Law Office, P.C., 3975 Fair Ridge Drive, Suite 20 North, Fairfax, VA, 22033, US

(73) Assignee: KABUSHIKI KAISHA KENWOOD, Hachiouji-shi, Tokyo (JP)

(21) Appl. No.: 12/680,786

(22) PCT Filed: Sep. 14, 2009
(86) PCT No.: PCT/JP2009/066021

§ 371 Date: Mar. 30, 2010

(30) Foreign Application Priority Data
Sep. 30, 2008 (JP) 2008-252513

(51) Int. Cl. H04N 5/93

(52) U.S. Cl. 386/54; 386/E05.003

(57) ABSTRACT

The present invention has a function for an image audio reproduction system so that an AV amplification device and other reproduction apparatuses which are connected via HDMI cables are not automatically powered off even when an image signal has not been inputted to an image signal display apparatus. The image audio reproduction system according to the present invention basically includes an image signal display apparatus (10) for displaying the image signal; a reproduction apparatus (40) for reproducing media contents including at least one of the image signal and an audio signal; and an AV amplification device (20) to which the image signal or the audio signal from the reproduction apparatus is inputted, and which outputs the image signal and/or the audio signal to the image signal display apparatus if the image signal is included. The image signal display apparatus and the AV amplification device are being connected via the HDMI cable, and the AV amplification device and the reproduction apparatus are being connected via the HDMI cable, and moreover, the AV amplification device includes CEC signal control means 24 for controlling a CEC signal from the image signal display apparatus.

### TECHNICAL FIELD

The present invention relates to a system, an AV amplification device and a program for reproducing an image signal and an audio signal.

### BACKGROUND ART

An image audio reproduction system has been proposed in which a television apparatus that is an image signal display apparatus, a DVD (Digital Versatile Disc) player, and an AV (Audio Video, hereinafter referred to as “AV”) amplification device are connected via cables of HDMI (High Definition Multimedia Interface) standard (hereinafter referred to as “HDMI cables”), respectively. The player is not limited to the DVD player, and also includes a hard disk recorder, a personal computer, a portable player, or an apparatus for receiving an image signal or an audio signal via a network, which are connected via the HDMI cables to configure an image audio reproduction system.

A CEC signal line for transmitting and receiving CEC (Consumer Electronics Control, hereinafter referred to as “CEC”) commands for controlling each device connected via the HDMI cable is included in the HDMI cable, and the player can be operated or the like by a remote controller of the television apparatus, by using the CEC commands. Techniques using these CEC commands have been applied for patent (see Patent Documents 1 and 2).

One of these CEC commands is a system standby message. System standby is, for example, a function in which when the image signal has not been inputted to the television apparatus for a certain period of time, it is regarded that there is no input to the television apparatus, and if the certain period of time has elapsed, the television apparatus is set in a sleep state, a standby message is transmitted to peripheral devices connected via the HDMI cables, and thereby, the AV amplification device and the player which are the peripheral devices that have received the standby message can be powered off. Thereby, other apparatuses can also be powered off with a one-touch operation by powering off the television apparatus, and thus, operations of the devices included in the system become easy, and a power-on state of any unnecessary device is eliminated, which has an advantage that power consumption of the entire system can be reduced.

### Patent Document 1: Japanese Patent Application Laid-Open No. 2007-179707

### Patent Document 2: Japanese Patent Application Laid-Open No. 2008-54156

### DISCLOSURE OF THE INVENTION

### Problems to be Solved by the Invention

Incidentally, if a reproduction apparatus for reproducing media contents stored in a disc such as a DVD is considered, there is a time when the image signal is not outputted from the reproduction apparatus. A DVD reproduction apparatus can also reproduce an ordinary music CD, and when the music CD is being reproduced, the audio signal is outputted while the image signal is not outputted.

At this time, since the image signal is not transmitted from the reproduction apparatus—the AV amplification device which are being connected, the television apparatus itself which is connected via the HDMI cable is set in the sleep state, and transmits the standby message to the AV amplification device by using the CEC signal line in the HDMI cable. Since this standby message is also directly transmitted to the reproduction apparatus which is connected to the AV amplification device via the HDMI cable, when the reproduction apparatus and the AV amplification device receive the standby message, the reproduction apparatus and the AV amplification device are powered off. As a result thereof, when music is listened to from the CD, it is necessary to perform a power-on operation for the reproduction apparatus and the AV amplification device again. Consequently, setups of the AV amplification device and the reproduction apparatus when images such as a movie are attempted to be watched from the DVD or a BD (Blu-ray Disc) need to be changed when simply the music is attempted to be listened to from the CD.

A description of this operation will be described with reference to FIGS. 9 and 10.

FIG. 9 is an example of an image audio reproduction system in which a television apparatus 10, an AV amplification device 20, and a DVD player 40 which is a disc reproduction apparatus are connected via HDMI cables 60 and 61. The television apparatus 10 and the AV amplification device 20 are being connected via the HDMI cable 60, and the AV amplification device 20 and the DVD player 40 are being connected via the HDMI cable 61, respectively. It should be noted that this image audio reproduction system is an example of a configuration including a minimum unit of devices, and a configuration may be possible in which not only the DVD player 40 but also a recorder for recording and reproducing the images and the music, a PC having a similar function or the like is separately connected to the AV amplification device 20 via the HDMI cable. Moreover, a configuration may be possible in which the recorder for recording and reproducing the images and the music is directly connected to the television apparatus 10 via the HDMI cable.

FIG. 10 is a flowchart explaining operations when the AV amplification device 20 and the DVD player have received a CEC message from the television apparatus 10.

When the television apparatus 10 does not receive the image signal from the AV amplification device 20 via the HDMI cable 60, the television apparatus 10 regards that there is no image signal input, and is set in the sleep state. Then, the television apparatus 10 transmits the standby message to the AV amplification device 20 via the CEC signal line in the HDMI cable 60. The AV amplification device 20 determines whether or not the standby message has been received as a CEC control message from the CEC signal line (step S72), and if the standby message has been received, and if the AV amplification device 20 is during power-on, the AV amplification device 20 performs power-off processing (step S74).

Instead of the standby message, if the other messages have been received (steps S72 and S75), processing for the received messages are performed (step S76). Such CEC messages include a recording instruction issued from the television apparatus 10 side to the recorder as the player with a one-touch operation, a command for performing recording reservation, and the like. It should be noted that the standby message is transmitted to the DVD player via the AV amplification device 20, and the processing shown in FIG. 10 is also performed in the DVD player 40.

In this way, when the image signal is not transmitted from the AV amplification device 20 via the HDMI cable 60, the television apparatus 10 transmits the standby message to the AV amplification device 20 and the DVD player 40 which is further connected, and thus, those devices are automatically powered off, and if the music CD is being reproduced, the AV amplification device 20 and the DVD player 40 are powered off.

Moreover, it also has been proposed to change the setups of the player as the reproduction apparatus and the AV amplification device each time when only the music or other audio signals are reproduced from the CD, and when the image signal is reproduced from the DVD or the like, while there is a problem in that it is cumbersome for a user to change the setups each time.

The present invention solves the problem as described above, and an object of the present invention is to cause the AV amplification device and other reproduction apparatuses, which are connected via the HDMI cables, not to be automatically powered off even when the image signal has not been inputted to the image signal display apparatus.

### Means for Solving the Problems

In a first aspect, the present invention is an image audio reproduction system, including an image signal display apparatus for displaying an image signal; a reproduction apparatus for reproducing media contents including at least one of the image signal and an audio signal; and an AV amplification device to which the image signal or the audio signal from the reproduction apparatus is inputted, and which outputs the image signal and/or the audio signal, wherein the image signal display apparatus and the AV amplification device are being connected via a cable of HDMI standard, and the AV amplification device and the reproduction apparatus are being connected via a cable of the HDMI standard, and furthermore, the AV amplification device includes CEC signal control means for controlling a signal of CEC standard from the image signal display apparatus.

It should be noted that the AV amplification device is connected to the reproduction apparatus via another cable other than the cable of the HDMI standard, and acquires information on the reproduction apparatus, and the CEC signal control means can detect that the reproduction apparatus is not outputting the image signal, and depending on the acquired information on the reproduction apparatus, can operate not to transmit a standby message signal from the image signal display apparatus.

In a second aspect, the present invention is an image audio reproduction system, including an image signal display apparatus for displaying an image signal; a reproduction apparatus for reproducing media contents including at least one of the image signal and an audio signal; and an AV amplification device to which the image signal or the audio signal from the reproduction apparatus is inputted, and which outputs the image signal and/or the audio signal to the image signal display apparatus, wherein the image signal display apparatus and the AV amplification device are connected via a cable of HDMI standard, the AV amplification device and the reproduction apparatus are connected via a cable of the HDMI standard, and also connected via another cable other than the cable of the HDMI standard in order to acquire information on the reproduction apparatus, and the AV amplification device includes means for, when it has been detected via the another cable that the reproduction apparatus is not outputting the image signal, operating to transmit a power-on message signal as a signal of CEC standard to the reproduction apparatus.

The AV amplification device can include means for, if the reproduction apparatus is reproducing a recording medium in which the audio signal has been recorded, operating to acquire information on an address which is being reproduced, and to transmit a signal for instructing to skip up to a position of the acquired address information, even if a standby message signal which is the signal of the CEC standard is transmitted from the image signal display apparatus.

In a third aspect, the present invention is an AV amplification device which is connected to an image signal display apparatus and a reproduction apparatus for reproducing media contents including at least one of an image signal and an audio signal, respectively, via cables of HDMI standard, wherein the AV amplification device is configured so that the image signal or the audio signal from the reproduction apparatus is inputted, and is configured to output the image signal and/or the audio signal to the image signal display apparatus, and the AV amplification device includes CEC signal control means for controlling a signal of CEC standard from the image signal display apparatus.

Information on the reproduction apparatus is acquired from the reproduction apparatus via another cable other than the cable of the HDMI standard, and if the CEC signal control means has detected that the reproduction apparatus is not outputting the image signal, the CEC signal control means can operate not to transmit a standby message signal from the image signal display apparatus, depending on the acquired information on the reproduction apparatus.

In a fourth aspect, the present invention is an AV amplification device which is connected to an image signal display apparatus and a reproduction apparatus for reproducing media contents including at least one of an image signal and an audio signal, respectively, via cables of HDMI standard, wherein the AV amplification device is configured so that the image signal or the audio signal from the reproduction apparatus is inputted, and is configured to output the image signal and/or the audio signal to the image signal display apparatus, the AV amplification device and the reproduction apparatus are connected via another cable other than the cable of the HDMI standard in order to acquire information on the reproduction apparatus, and the AV amplification device includes means for, if it has been detected via the another cable that the reproduction apparatus is not outputting the image signal, operating to transmit a power-on message signal as a signal of CEC standard to the reproduction apparatus.

There can be included means for, if the reproduction apparatus is reproducing a recording medium in which the audio signal has been recorded, acquiring information on an address which is being reproduced, and transmitting a signal for instructing to skip up to a position of the acquired address information, even if a standby message signal which is the signal of the CEC standard is transmitted from the image signal display apparatus.

In addition, the present invention can also be understood as a computer program, which is installed in a computer and thereby can cause the computer to function as the CEC signal control means of the AV amplification device as described above, or to function as the means for transmitting the power-on message signal of the AV amplification device. This program can be installed in the computer via a recording medium or a communication line. Moreover, this program can also include a program which has been encrypted or to which compression processing has been applied.

### EFFECT OF THE INVENTION

According to the present invention, there is provided an effect that, when the reproduction apparatus is reproducing only audio, even if it is regarded that the image signal is not inputted from the image signal display apparatus, and a standby message is transmitted to the AV amplification device or the reproduction apparatus, which is connected to the image signal display apparatus via the HDMI cable, the AV amplification device or the reproduction apparatus is not automatically powered off, and it is not necessary to perform any complicated setup when the audio signal is reproduced and when the image signal is reproduced.

### BRIEF DESCRIPTION OF THE DRAWINGS

FIG. 1 is a block diagram showing a configuration of an image audio reproduction system according to a first embodiment of the present invention;

FIG. 2 is a block diagram showing a configuration of an AV amplification device in the image audio reproduction system shown in FIG. 1;

FIG. 3A is a half of a flowchart explaining CEC signal processing in the AV amplification device shown in FIG. 2;

FIG. 3B is a remaining half of a flowchart explaining CEC signal processing in the AV amplification device shown in FIG. 2;

FIG. 4 is a flowchart explaining DVD player state monitoring processing in the AV amplification device shown in FIG. 2;

FIG. 5 is a block diagram showing the configuration of the image audio reproduction system of a second embodiment of the present invention;

FIG. 6 is a block diagram showing the configuration of the AV amplification device in the image audio reproduction system of a third embodiment of the present invention;

FIG. 7A is a half of a flowchart explaining the CEC signal processing in the AV amplification device shown in FIG. 6;

FIG. 7B is a remaining half of a flowchart explaining the CEC signal processing in the AV amplification device shown in FIG. 6;

FIG. 8 is a flowchart explaining the DVD player state monitoring processing in the AV amplification device in the image audio reproduction system of the third embodiment of the present invention;

FIG. 9 is a block diagram showing a configuration of a conventional image audio reproduction system; and

FIG. 10 is a flowchart explaining operations of the AV amplification device in the conventional image audio reproduction system.

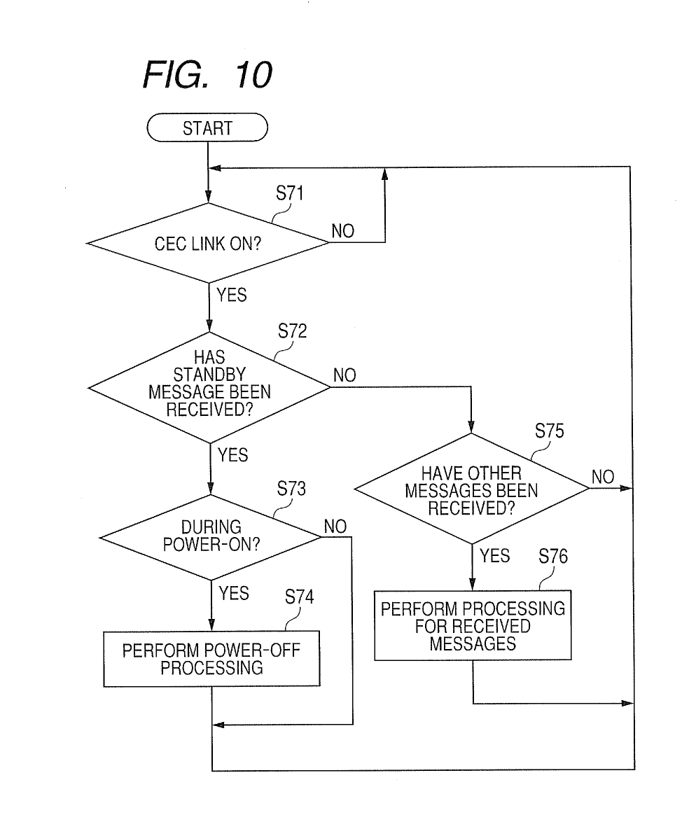

### DESCRIPTION OF SYMBOLS

10 Television apparatus (image signal display apparatus)
20 AV amplification device
40 DVD player (reproduction apparatus)
60, 61, 62, 63 HDMI cable
64, 65 AV cable
24 CEC blocking function unit (CEC signal control means)

### BEST MODES FOR CARRYING OUT THE INVENTION

Hereinafter, embodiments of the present invention will be described with reference to the drawings.

### First Embodiment

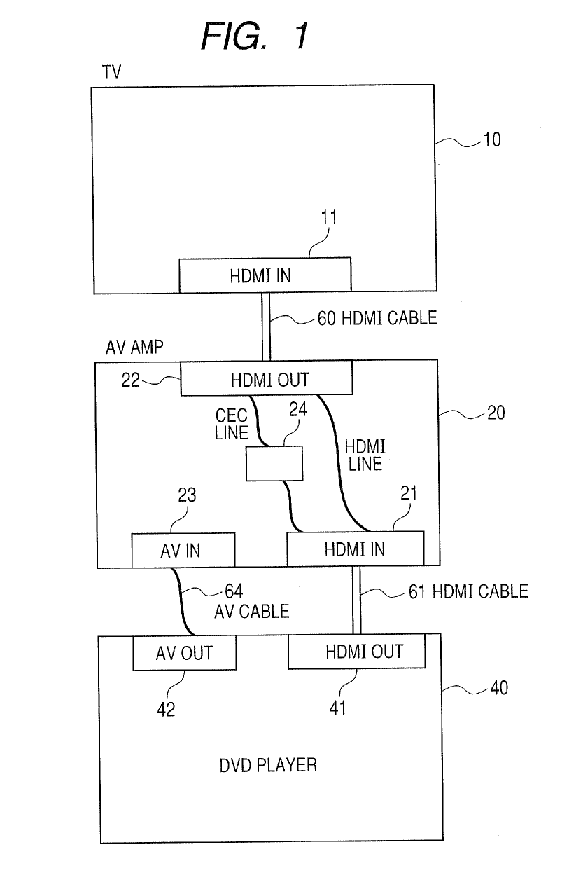

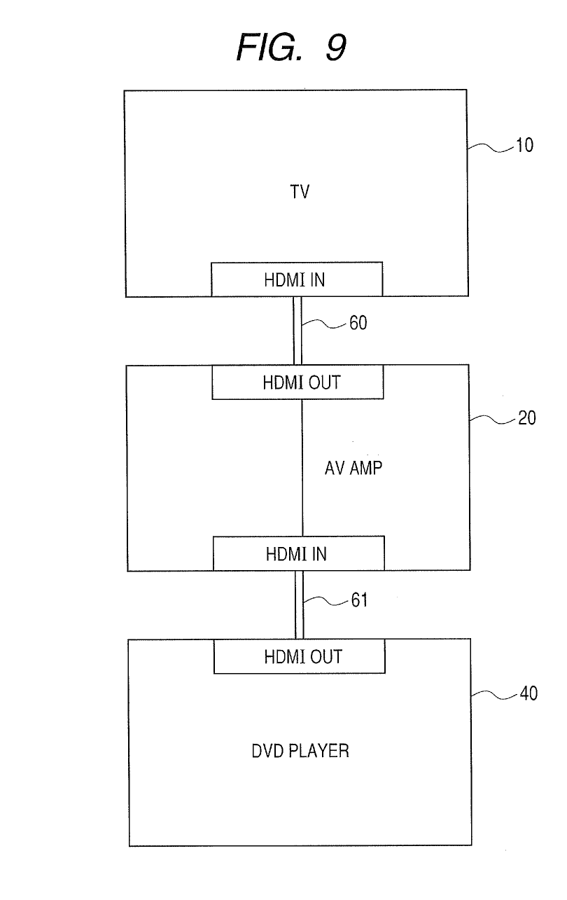

FIG. 1 shows a configuration of an image audio reproduction system which is a first embodiment of the present invention. In the first embodiment of the present invention, as a minimum configuration of the system, there are included a television apparatus 10 which is an image signal display apparatus, an AV amplification device 20 including a speaker, and a DVD player 40 as a reproduction apparatus, and the television apparatus 10 and the AV amplification device 20 are being connected via an HDMI cable 60, and the AV amplification device 20 and the DVD player 40 are being connected via an HDMI cable 61, and also being connected via an AV cable 64. This configuration is similar to the configuration shown in FIG. 9.

One end of the HDMI cable 60 is being connected to an HDMI input terminal (HDMI IN) 11 of the television apparatus 10, and the other end thereof is being connected to an HDMI output terminal (HDMI OUT) 22 of the AV amplification device 20. Moreover, the HDMI cable 61 is being connected to an HDMI input terminal 21 of the AV amplification device 20 and an HDMI output terminal 41 of the DVD player 40. Moreover, the AV amplification device 20 and the DVD player 40 are being connected to an AV input terminal (AV IN) 23 of the AV amplification device 20 and an AV output terminal (AV OUT) 42 of the DVD player 40 via another AV cable 64 other than the HDMI cable 61.

The AV amplification device 20 is provided with a CEC blocking function unit 24 for blocking a CEC message (command) of the HDMI cable 60, as CEC signal control means. This CEC blocking function unit 24 can perform the blocking by disconnecting a CEC signal line or preventing a signal from arriving at a CEC connecting terminal portion of the HDMI cable, in a hardware manner, while the CEC blocking function unit can perform the blocking by detecting a standby message from the television apparatus 10, and ignoring the standby message, or performing processing such as disablement of the standby message, by software of a control unit in the AV amplification device 20. In the present embodiment, an example will be described in which the standby message is blocked by signal processing operations (software processing) of the control unit in the AV amplification device 20.

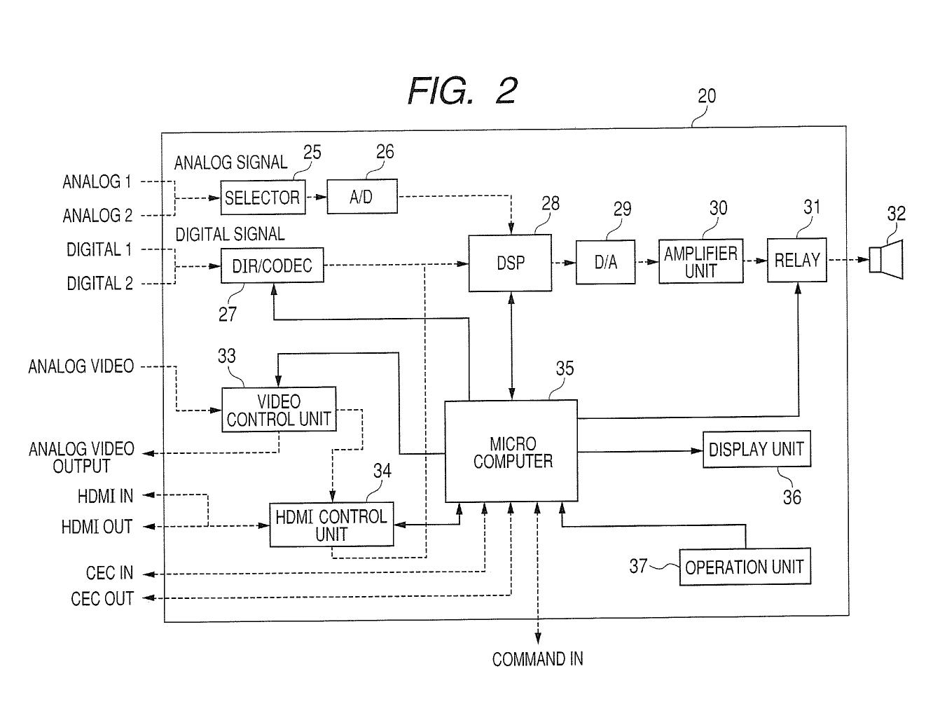

FIG. 2 is a diagram showing a block configuration of the AV amplification device 20. Here, a CEC blocking function is processed by an internal control circuit, specifically, a micro computer 35, in a software manner.

The AV amplification device shown in FIG. 2 serves an amplification function for an image signal and an audio signal as well as an output function for other apparatuses, and also serves reception, transmission and control functions for an HDMI signal.

The AV amplification device 20 has a function of processing an analog audio or image signal, and has a function of processing the analog audio signal, a function of processing a digital audio signal, a function of processing the analog image signal, and a function of processing the HDMI signal inputted from the HDMI cable.

The functions of processing the analog audio signal and the digital audio signal are served by a selector 25, an A/D converter 26, a DIR/CODEC (direct digital inputs/codec) unit 27, a DSP (Digital signal processor) 28, a D/A converter (Digital/Analog Converter) 29, an amplifier unit 30, a relay 31, a speaker 32, and the micro computer 35 in cooperation with one another. The function of processing the analog image signal is served by a VIDEO control unit and the micro computer 35. The function of processing the HDMI signal is served by an HDMI control unit 34 and the micro computer 35 in cooperation with each other. Moreover, the AV amplification device 20 is provided with a display unit 36 and an operation unit 37 so that a processing status can be displayed and the AV amplification device 20 can be operated via the operation unit 37.

The analog audio signal inputted to terminals of analog 1 and 2 is converted into a digital signal by the selector 25 and the A/D converter 26, and the signal processing is performed for the digital signal by the DSP 28, and then the digital signal is outputted to the speaker 32 via the D/A converter 29, the amplifier unit 30, and the relay 31 in which the output is switched.

Moreover, the audio signal which is the digital signal is inputted from terminals of digital 1 and 2, encoded or decoded by the DIR/CODEC unit 27 so that the audio signal can be processed in the DSP 28, processed in the DSP 28, and similarly to the analog audio signal, outputted to the speaker 32 via the D/A converter 29, the amplifier unit 30 and the relay 31.

The analog image signal inputted from an analog video terminal is processed by the VIDEO control unit 33, and outputted to an analog video output terminal.

The signal (a digital image signal or the digital audio signal) inputted from the HDMI IN terminal via the HDMI cable 61 by the DVD player 40 is processed by the HDMI control unit 34, and outputted from the HDMI OUT terminal to the television apparatus 10 side. A CEC signal of the HDMI cable 61 is inputted from a CEC IN terminal to the micro computer 35, processed by the micro computer 35, and outputted to a CEC OUT terminal. Reproduced media information is also inputted from the DVD player 40 via the AV cable 64 to the micro computer 35, and the micro computer 35 recognizes which medium is being reproduced by the DVD player 40.

Another embodiment has a form in which the CEC signal line is independently inputted to the micro computer 35 at each of HDMI IN and HDMI OUT within the AV amplification device 20, and the AV amplification device 20 can also acquire a state of the DVD player 40 via another AV cable 64 other than the HDMI cable 61.

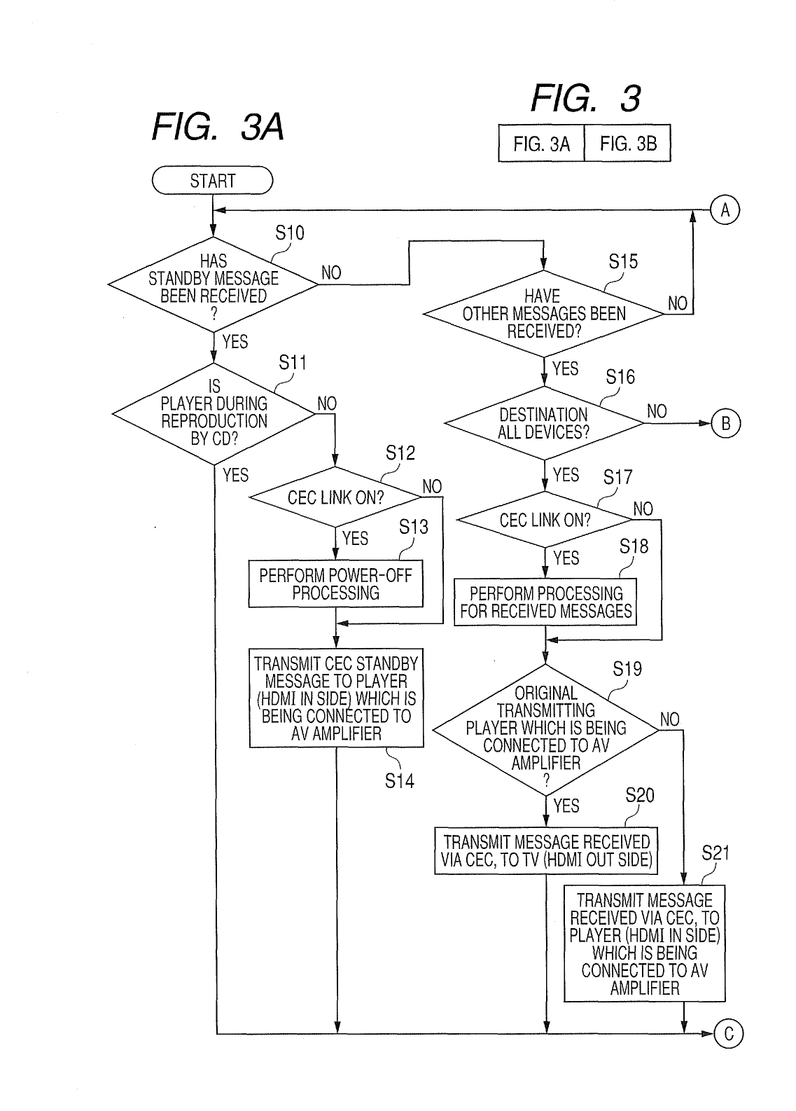

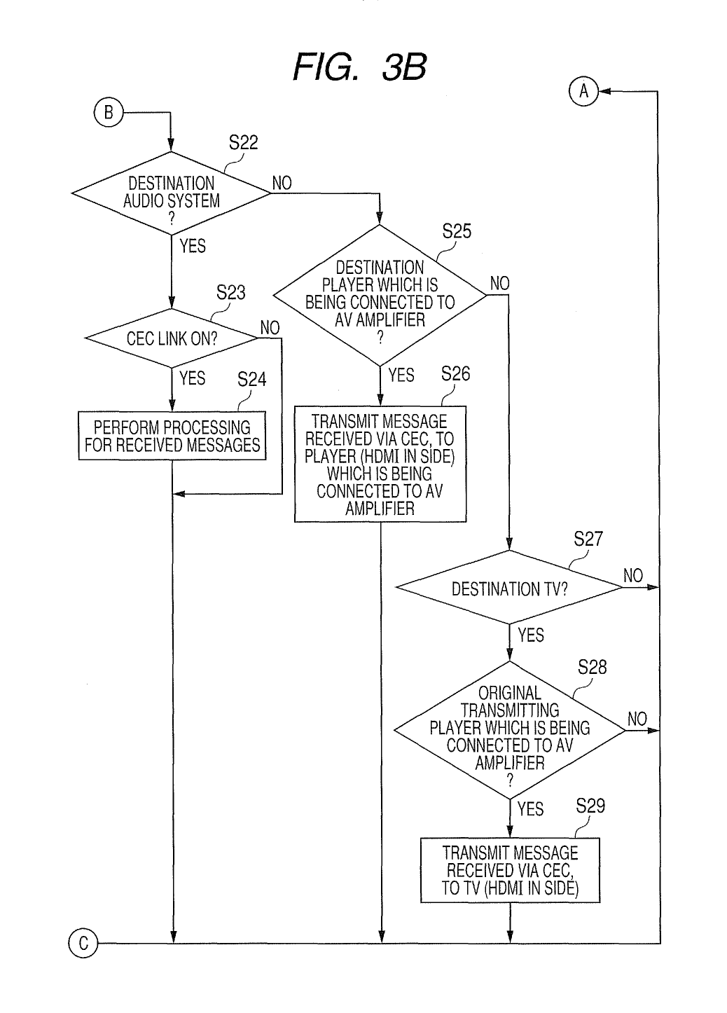

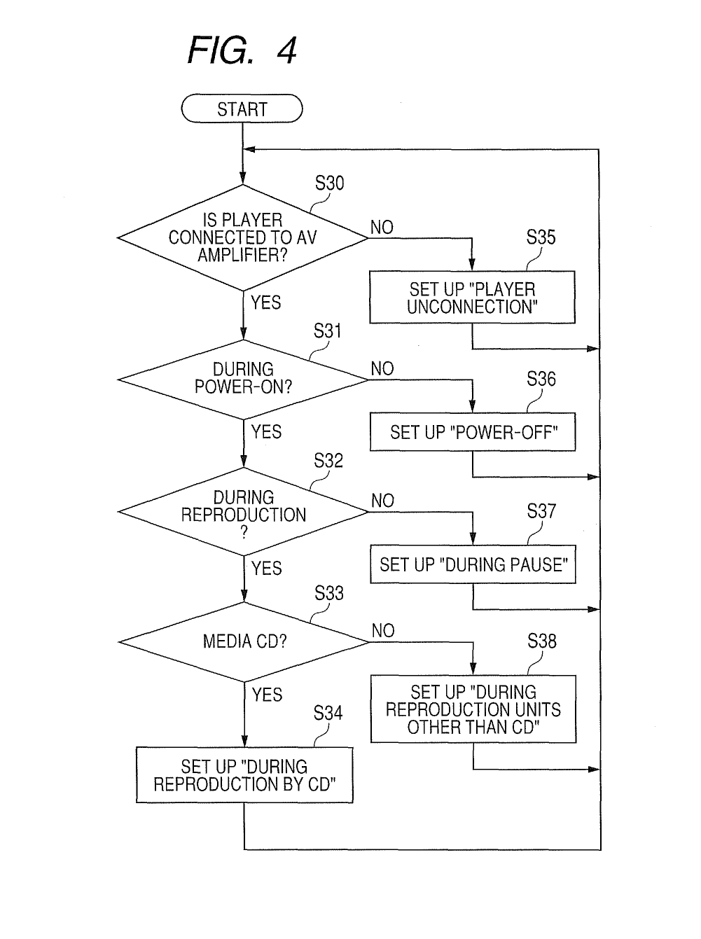

Next, with reference to flowcharts of FIGS. 3 and 4, operations of the AV amplification device 20 and the DVD player 40 will be described. FIG. 3A and FIG. 3B show a flowchart explaining CEC message processing in the AV amplification device 20, and FIG. 4 is a flowchart explaining processing for monitoring the state of the DVD player 40, in the AV amplification device 20.

When the AV amplification device 20 receives the standby message as the CEC message from the television apparatus 10 (step S10), the AV amplification device determines whether or not the DVD player 40 is during reproduction by a CD (reproduction of only the audio signal of the CD) (step S11). If the DVD player 40 is during the reproduction by the CD, reception of a next message is waited for without performing processing for the standby message, and also without transmitting the standby message to the DVD player 40. Thereby, even if the standby message is received, neither the AV amplification device 20 nor the DVD player 40 is powered off, and the reproduction by the CD is continued, and thus, a user is not required to take the trouble to perform power-on processing.

If the DVD player 40 is not during the reproduction by the CD, it is confirmed whether or not a CEC link has been set up to be “ON” (step S12), and if the CEC link has been set up to be “ON”, the AV amplification device 20 which is the device itself is powered off (step S13), and a CEC standby message is transmitted to the DVD player 40 which is being connected to the AV amplification device 20 itself (step S14). Thereby, if the DVD player 40 is not during the reproduction by the CD, the AV amplification device 20 and the DVD player 40 are set in a power-off state by the standby message from the television apparatus 10.

If the AV amplification device 20 has received the other messages instead of the standby message (step S15), and if a destination is all the apparatuses which are being connected (Yes in step S16), it is confirmed whether or not the CEC link has been set up (step S17), and if Yes, processing for the received messages is performed (step S18). It is determined whether or not an original transmitter of the messages is the DVD player 40 which is being connected to the AV amplification device 20 (step S19), and if the original transmitter is the DVD player 40, the CEC message received via the CEC signal line is transmitted to the television apparatus 10 (step S20). If the original transmitter is not the DVD player 40, the message received via the CEC signal line is transmitted to the DVD player 40 which is being connected to the AV amplification device 20 (step S21). According to this CEC message processing, except the standby message, the CEC message from the original transmitter can, so to say, pass through to be transmitted to other devices which are being connected via the HDMI cable.

If the received CEC message is not the standby message, and the destination thereof is the audio system (the AV amplification device 20 itself) (Yes in step S22), it is confirmed whether or not the CEC link has been set up (step S23), and subsequently, if Yes, the processing for the received messages is performed (step S24). If the destination is the DVD player 40 which is connected to the device itself (Yes in step S25), the received CEC message is transmitted to the DVD player 40 which is being connected (step S26). If the destination is for the television apparatus 10 (Yes in step S27), it is confirmed that the original transmitter is the DVD player 40 which is being connected to the AV amplification device 20 itself (step S28), and if Yes, the message received via the CEC signal line is transmitted to the television apparatus 10 (step S29).

If No in steps S15, S27 and S28, and when the processing in steps S14, S20, S21, S24, S26 and S29 has been terminated, the AV amplification device 20 is set in a state of waiting for the next message. It should be noted that the determination and the control processing for the transmission and reception of the messages which are shown in this flowchart are performed by the micro computer 35 in the AV amplification device 20.

Next, the flowchart explaining control by monitoring the state of the DVD player 40 via the AV cable 64 in the AV amplification device 20 is shown in FIG. 4 and will be described.

It is confirmed whether or not the DVD player 40 is being connected to the AV amplification device 20 (step S30). If Yes, the processing proceeds to step S31, and if the DVD player 40 is during power-on (Yes in step S31) and is during reproduction by contents (Yes in step S32), and the contents are a media CD (audio) (Yes in step S33), “during reproduction by CD” is set up in the DVD player 40 (step S34). Thereby, as shown in step S11 of the flowchart of FIG. 3A, in a case of during the reproduction by the CD, the standby message is blocked and is not transmitted to the DVD player 40, and moreover, input of the standby message to the device itself is disabled, and the reproduction by the CD can be continued.

It should be noted that, if the DVD player 40 is not being connected to the AV amplification device 20 (No in step S30), “player unconnection” is set up (step S35). Moreover, if the DVD player 40 is not during power-on (No in step S31), “player power-off” is set up (step S36). In a case of not during the reproduction by the medium (No in step S32), “during pause of reproduction operation” is set up (step S37). In a case of not during the reproduction by the media CD (No in step S33), “during reproduction units other than CD” is set up (step S38).

Since an operating state of the DVD player 40 is monitored via the AV cable 64, and the setups in steps S34 to S38 are previously performed, even if the standby message arrives from the television apparatus 10, the AV amplification device 20 comprehends a current state of the DVD player 40, and thereby can perform corresponding processing for the standby message. Particularly, in the case of during the reproduction by the CD, the standby message from the television apparatus 10 is ignored, or disabled, or masked so as to be blocked, and thereby, the DVD player 40 is not set in the standby state so as to be powered off, and the AV amplification device 20 which is the device itself is not powered off either, and the reproduction by the CD can be continued.

### Second Embodiment

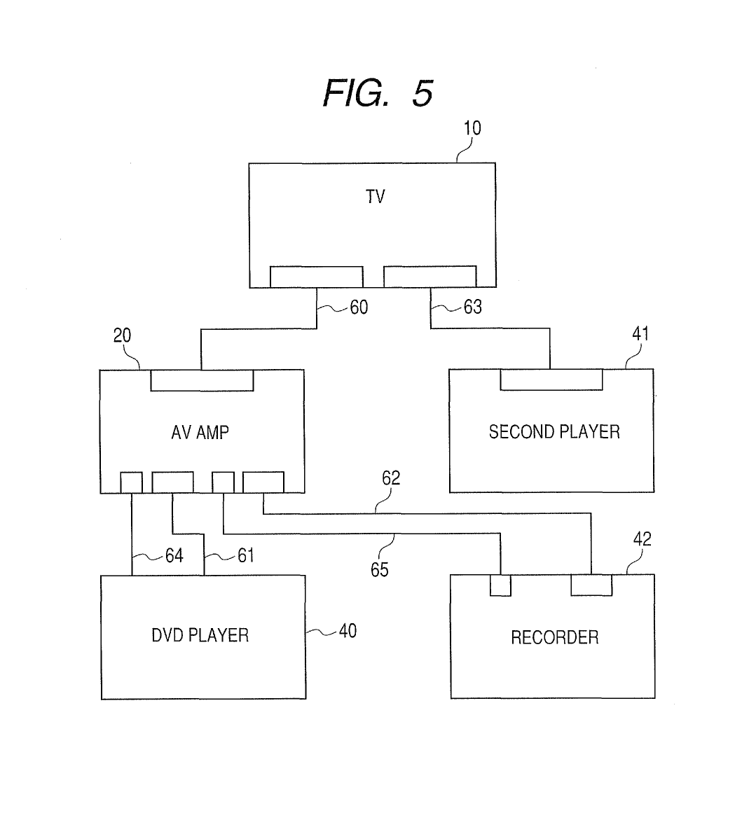

FIG. 5 is a diagram showing the configuration of the image audio reproduction system according to a second embodiment of the present invention. This configuration is an example of the image audio reproduction system in which a plurality of AV apparatuses are connected via the HDMI cables.

Here, the television apparatus 10 is configured to be connected to the AV amplification device 20 and a second player 41 via HDMI cables 60 and 63, respectively, and the AV amplification device 20 is configured to be connected to the DVD player 40 which is a first player, and a recorder 42, via HDMI cables 61 and 62, and to be connected to the DVD player 40 and the recorder 42 via other AV cables 64 and 65 other than the HDMI cables 61 and 62, respectively, so that the state thereof is being monitored. It should be noted that the same reference numeral is assigned to the same device as the first embodiment and will be described.

In this system, for example, in a case where the second player 41 is a BD player, and the recorder 42 is a hard disk recorder or a DVD player, when the image signal is not inputted to the television apparatus 10, even if the television apparatus 10 has outputted the standby message, the second player 41 is powered off, while both the DVD player 40 and the recorder 42 are not powered off since the standby message which is the CEC message is blocked for the DVD player 40 and the recorder 42 by the AV amplification device 20. It should be noted that, conversely, since the CEC messages from the original transmitting DVD player 40 and the original transmitting recorder 42 are transmitted to destination devices, as explained in the flowchart shown in FIG. 3A and FIG. 3B, transmission processing for the CEC messages from the DVD player 40 and the recorder 42 to the television apparatus 10 is performed by the AV amplification device 20.

### Third Embodiment

Next, a third embodiment will be described. Although, in the first embodiment, the example has been described in which the standby message transmitted from the television apparatus 10 to the AV amplification device 20 is not transmitted to the DVD player 40 and is blocked if the DVD player 40 is reproducing the CD audio signal, in the third embodiment, an example will be described in which if the CD audio signal is being reproduced, a track number of the CD which is being reproduced in the DVD player 40 is separately acquired, and even if the DVD player 40 is powered off by the standby message, the AV amplification device 20 transmits a power-on message to power on the DVD player 40, and causes the DVD player 40 to skip up to the acquired CD track number and to perform the reproduction from a track which has been reproduced before.

A connection form with the cables and a device configuration are the same as FIG. 1. A different point is the configuration of the AV amplifier device 20. In other words, the television apparatus 10 and the AV amplification device 20 are being connected via the HDMI cable 60, and the AV amplification device 20 and the DVD player 40 are being connected via the HDMI cable 61 and the AV cable 64.

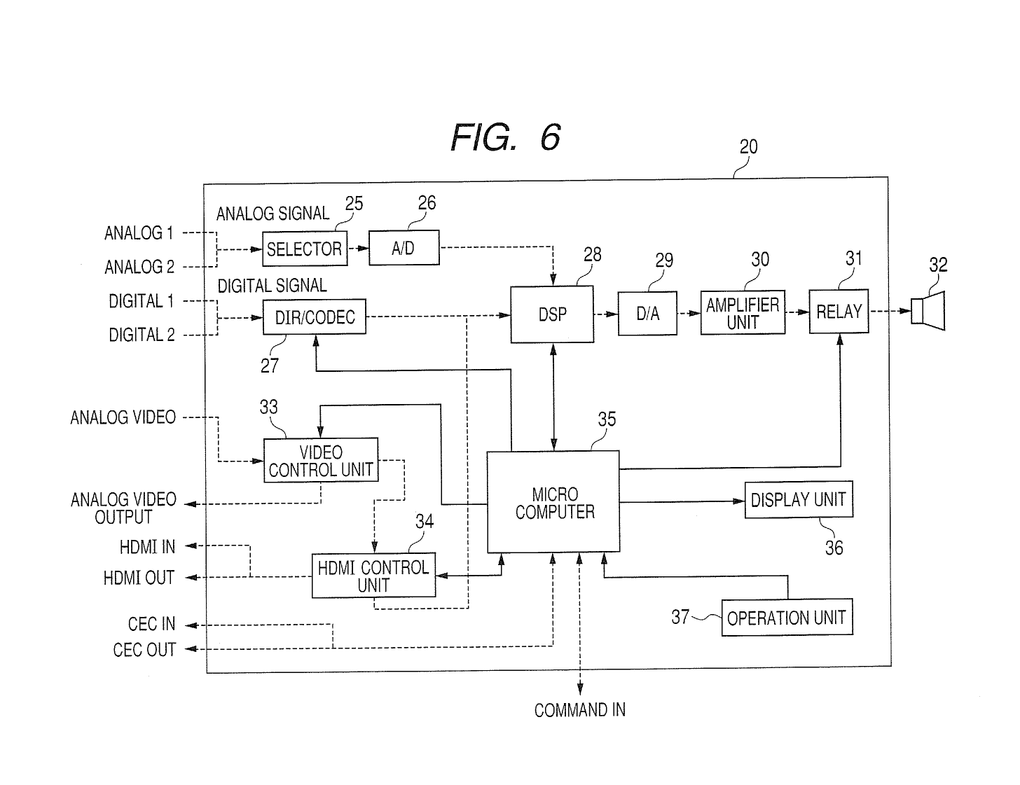

The configuration of the AV amplification device 20 of the third embodiment is shown in FIG. 6. A difference from the AV amplification device 20 of the first embodiment is a configuration of the CEC signal line, and there is the independent CEC signal line at each of HDMI IN and HDMI OUT in the configuration of FIG. 2, while the CEC signal line is not independent in the present embodiment. However, the AV amplification device 20 and the DVD player 40 are connected via the AV cable 64 separately from the HDMI cable 61, and the AV amplification device 20 is monitoring the state of the DVD player 40, which is the same as the first embodiment.

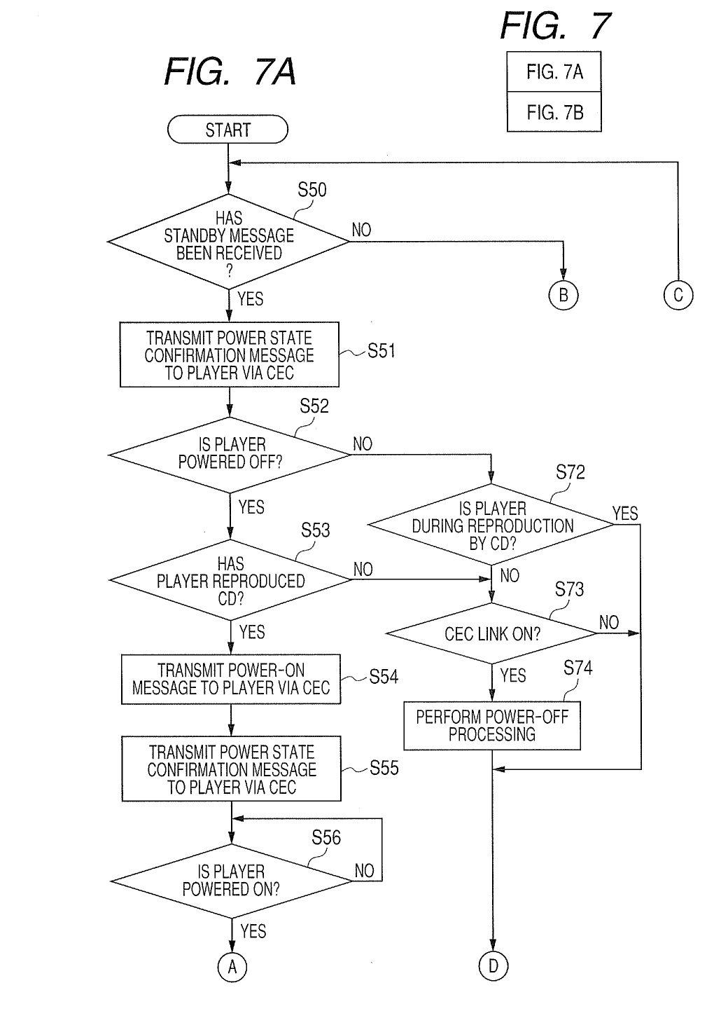

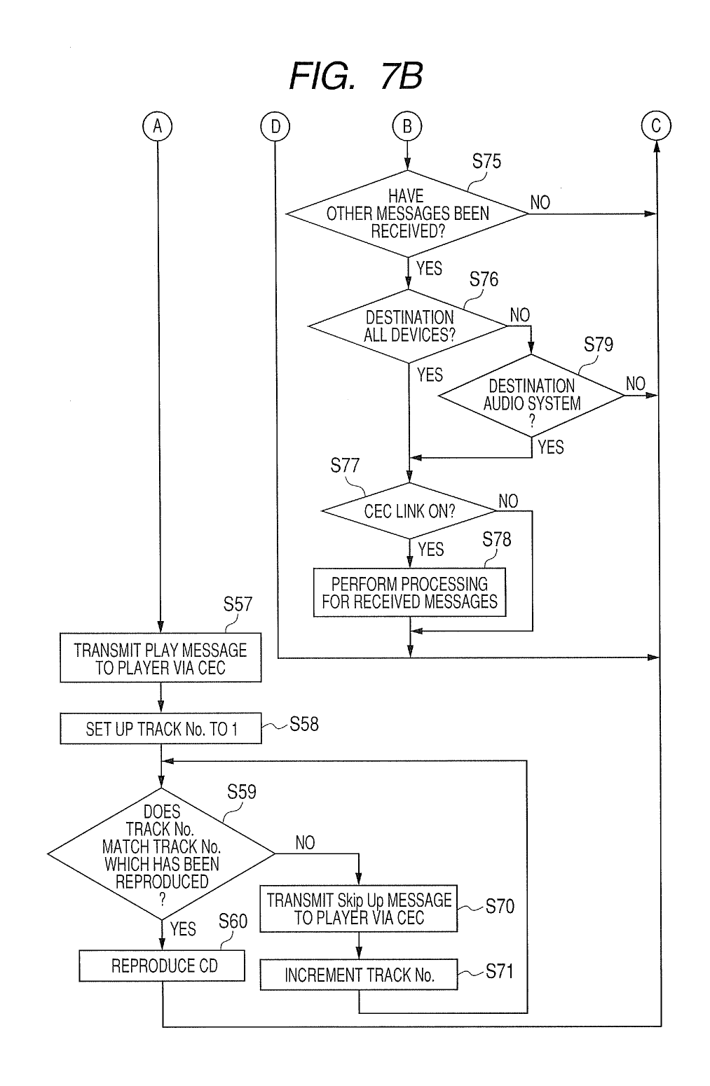

With reference to a flowchart shown in FIGS. 7A and 7B, the third embodiment will be described. FIGS. 7A and 7B correspond to the flowchart shown in FIGS. 3A and 3B, and explains the CEC message processing in the AV amplification device 20.

The third embodiment is characterized in that, if the standby message from the television apparatus 10 has been received, when the DVD player 40 has been powered off by the standby message, the AV amplification device 20 transmits the power-on message to the DVD player 40 to power on the DVD player 40, and causes the DVD player 40 to skip up to the acquired CD track number which has been reproduced until just before, by using the CEC message, and to control to continue the reproduction from before power-off.

If the AV amplification device 20 receives the standby message from the television apparatus 10 (Yes in step S50), the AV amplification device 20 transmits a power state confirmation message to the DVD player 40 via the CEC signal line (step S51). If the DVD player 40 is powered off (Yes in step S52), and the DVD player 40 have reproduced CD music (Yes in step S53), the power-on message is transmitted to the DVD player 40 via the CEC signal line (step S54). In the first embodiment, the standby message from the television apparatus 10 is blocked, while processing for blocking the standby message is not performed in the third embodiment. Instead, the third embodiment is different in that if the DVD player 40 has been powered off by the standby message, the power-on message of the CEC is transmitted to power on the DVD player 40.

The AV amplification device 20 transmits the power state confirmation message to the DVD player 40 via the CEC signal line (step S55), and if the DVD player 40 is powered on (Yes in step S56), the AV amplification device 20 transmits a play message via the CEC signal line (step S57). Then, the track number is set up to “1” (step S58), and if this track number which has been set up matches the track number which has been reproduced before power-off (Yes in step S59), the reproduction is directly continued (step S60). Here, if the track numbers do not match, a skip up message is transmitted to the DVD player 40 by the CEC message (step S70). According to this message, the DVD player 40 increments the track number (step S71). If the incremented track number matches the track number, the reproduction is continued (step S60).

It should be noted that, here, while skip up processing is performed from when the track number is set up to 1 to when the track number matches the track which has been reproduced, also, the AV amplification device 20 can previously store the track number during reproduction before power-off, and this track number can be transmitted to the DVD player 40 to instruct the reproduction. Moreover, the skip up can also be performed by using the CEC message, and the skip up can also be performed via another cable.

If the DVD player 40 is not powered off and is during the reproduction by the CD, the reproduction is directly continued (Yes in step S72), and the reception of the next message is waited for. If the DVD player 40 is not during the reproduction by the CD (No in step S72), and if the CEC link is “ON” (Yes in step S73), the power-off processing is performed (step S74). If the CEC link is not “ON” (No in step S73), the power-off processing is not performed, the reproduction by the CD is continued, and the reception of the next message is waited for.

If the received message is not the standby message (No in step S50), similarly to the operations of the first embodiment, if the other messages have been received (Yes in step S75), and if the destination is all the apparatuses, it is confirmed whether or not the CEC link has been set up (Yes in step S77), and then the processing for the received messages is performed (step S78). Here, steps S75, S76, S77 and S78 correspond to steps S15, S16, S17 and S18 of the first embodiment. Since step S79 corresponds to step S22, if No in step S79, the processing may not return to step S50, and like the first embodiment, the processing in step S25, S26, S27, S28 and S29 may be performed.

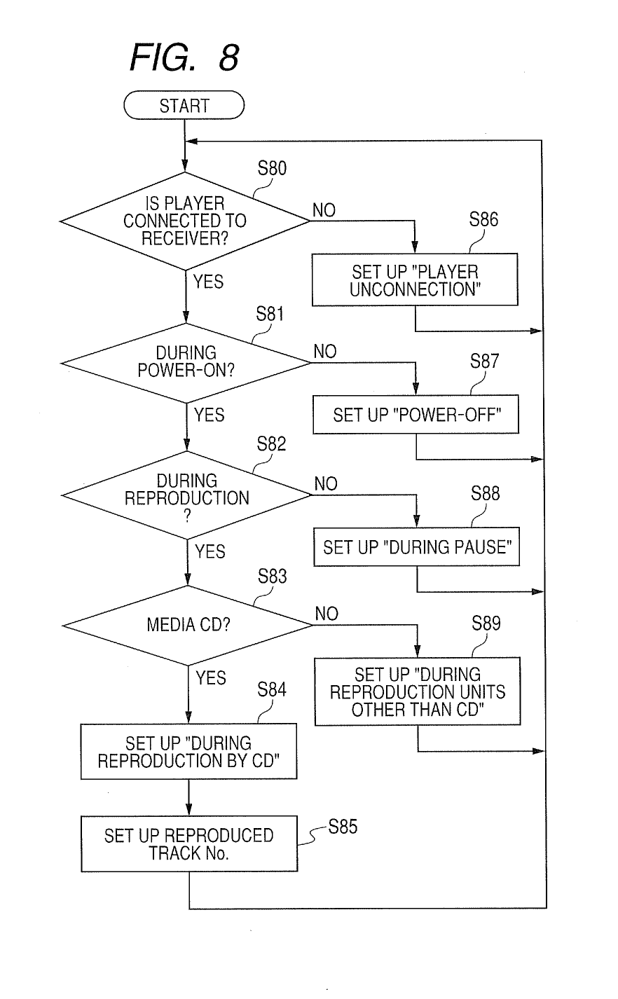

FIG. 8 is a flowchart explaining operations of monitoring the state of the DVD player 40 which is being connected to the AV amplification device 20, via another AV cable 64 other than the HDMI cable 61. In comparison with the corresponding flowchart of FIG. 4 of the first embodiment, if the medium during the reproduction has been the CD, only step S85 in which a reproduced track number is selected after “during reproduction by CD” is set up is different, and other steps are common.

In this third embodiment, the CEC signal line is the same as a conventional case, and the third embodiment is characterized in that if the standby message has arrived from the television apparatus 10 during the reproduction by the CD, and the DVD player 40 has been powered off, a power-on command which is the CEC message is transmitted to the player by using the HDMI cable 61 so as to control the reproduction by the CD to be practically continued. In addition, the track number of the CD during the reproduction is previously acquired via the AV cable 64 which is another cable other than the HDMI cable 61, and the reproduction from the track before power-off is performed. Thereby, without blocking the CEC signal line, according to the processing in the micro computer 35 in the AV amplification device 20, the reproduction can be continued from a reproduction state before the standby message has arrived, and thus, there is an effect that the user can continue the reproduction by the CD without performing any processing.

### Program Embodiment

In the above described first and second embodiments, the micro computer 35 in the AV amplification device 20 realize a function of blocking the standby message from the television apparatus 10 when it has been detected that the DVD player 40 is reproducing the CD of the audio signal. Moreover, in the third embodiment, a function of transmitting the power-on message to the DVD player 40 is realized. For this function of blocking or transmitting a CEC message signal, which is realized by the micro computer 35, the functions of the AV amplification device 20 of the first and second embodiments as well as the third embodiment can be realized by installing a program into an information processing apparatus.

It should be noted that, although the example in the case where the player is the DVD player 40 and reproduces the CD in which the audio signal has been recorded has been described in the above described embodiments, the DVD player 40 is an example, and the above described embodiments are not limited to the operations during the reproduction by the CD by the DVD player 40. The same applies to a case where a DVD in which only the music has been recorded is reproduced and the image signal is not outputted to the television apparatus. Moreover, the present invention is also applicable to the image audio reproduction system in a case where, instead of the image signal, only the audio signal has been outputted from a disc recorder other than the DVD player.

Furthermore, the present invention is applicable even if the DVD player 40 is a PC (personal computer) connected to the Internet, and is being connected to the AV amplification device 20 and the television apparatus 10 via the HDMI cables, and only the audio signal is outputted from the PC like the Internet radio broadcasting.

Moreover, as the image signal display apparatus, other than the television apparatus, a display apparatus of a PC having a similar function may be employed. Moreover, in the other embodiments, while the example of the CD has been described as a case where the reproduction is performed from the speaker, the present invention is also applicable to a case where the contents have been put in an MD, an HDD or the like.

1. (canceled)

2. An image audio reproduction system, comprising:
an image signal display apparatus for displaying an image signal;
a reproduction apparatus for reproducing media contents including at least one of the image signal and an audio signal; and
an AV amplification device to which the image signal or the audio signal from the reproduction apparatus is inputted, and which outputs the image signal and/or the audio signal,
wherein the image signal display apparatus and the AV amplification device are being connected via a cable of HDMI standard,
the AV amplification device and the reproduction apparatus are being connected via a cable of the HDMI standard, and
the AV amplification device comprises CEC signal control means for controlling a signal of CEC standard from the image signal display apparatus,
wherein the AV amplification device is connected to the reproduction apparatus via another cable other than the cable of the HDMI standard, and operates to acquire information on the reproduction apparatus, and
wherein the CEC signal control means detects that the reproduction apparatus is not outputting the image signal, and depending on the acquired information on the reproduction apparatus, operates not to transmit a standby message signal from the image signal display apparatus.

3. An image audio reproduction system, comprising:
an image signal display apparatus for displaying an image signal;
a reproduction apparatus for reproducing media contents including at least one of the image signal and an audio signal; and
an AV amplification device to which the image signal or the audio signal from the reproduction apparatus is inputted, and which outputs the image signal and/or the audio signal to the image signal display apparatus,
wherein the image signal display apparatus and the AV amplification device are connected via a cable of HDMI standard,
the AV amplification device and the reproduction apparatus are connected via a cable of the HDMI standard, and also connected via another cable other than the cable of the HDMI standard in order to acquire information on the reproduction apparatus, and
the AV amplification device includes means for, when it has been detected via the another cable that the reproduction apparatus is not outputting the image signal, operating to transmit a power-on message signal as a signal of CEC standard to the reproduction apparatus.

4. The image audio reproduction system according to claim 3, wherein
the AV amplification device includes means for, if the reproduction apparatus is reproducing a recording medium in which the audio signal has been recorded, operating to acquire information on an address which is being reproduced, and to transmit a signal for instructing to skip up to a position of the acquired address information, even if a standby message signal which is the signal of the CEC standard is transmitted from the image signal display apparatus.

5. (canceled)

6. An AV amplification device which is connected to an image signal display apparatus and a reproduction apparatus for reproducing media contents including at least one of an image signal and an audio signal, respectively, via cables of HDMI standard,
wherein the AV amplification device is configured so that the image signal or the audio signal from the reproduction apparatus is inputted, and is configured to output the image signal and/or the audio signal to the image signal display apparatus, and
the AV amplification device comprises CEC signal control means for controlling a signal of CEC standard from the image signal display apparatus,
wherein the AV amplification device acquires information on the reproduction apparatus from the reproduction apparatus via another cable other than the cable of the HDMI standard, and
wherein if the CEC signal control means has detected that the reproduction apparatus is not outputting the image signal, the CEC signal control means operates not to transmit a standby message signal from the image signal display apparatus, depending on the acquired information on the reproduction apparatus.

7. An AV amplification device which is connected to an image signal display apparatus and a reproduction apparatus for reproducing media contents including at least one of an image signal and an audio signal, respectively, via cables of HDMI standard,
wherein the AV amplification device is configured so that the image signal or the audio signal from the reproduction apparatus is inputted, and is configured to output the image signal and/or the audio signal to the image signal display apparatus,
the AV amplification device and the reproduction apparatus are connected via another cable other than the cable of the HDMI standard in order to acquire information on the reproduction apparatus, and
the AV amplification device comprises means for, if it has been detected via the another cable that the reproduction apparatus is not outputting the image signal, transmitting a power-on message signal as a signal of CEC standard to the reproduction apparatus.

8. The AV amplification device according to claim 7, comprising:
means for, if the reproduction apparatus is reproducing a recording medium in which the audio signal has been recorded, operating to acquire information on an address which is being reproduced, and to transmit a signal for instructing to skip up to a position of the acquired address information, even if a standby message signal which is the signal of the CEC standard is transmitted from the image signal display apparatus.

9. (canceled)

10. A program which is installed in a computer to cause the computer to function as:
means for transmitting a power-on message signal of an AV amplification device according to claim 7.
